(19) United States
(12) Patent Application Publication
(10) Pub. No.: US 2016/0181076 A1
(43) Pub. Date: Jun. 23, 2016

(54) Tuning a Mass Spectrometer Using Optimization

(71) Applicant: Thermo Finnigan LLC, San Jose, CA (US)

(72) Inventor: Johnathan Wayne SMITH, San Jose, CA (US)

(73) Assignee: Thermo Finnigan LLC

(21) Appl. No.: 14/575,802

(22) Filed: Dec. 18, 2014

(51) Int. Cl. H01J 49/00; H01J 49/42

(52) U.S. Cl. CPC H01J 49/0009; H01J 49/4215

(57) ABSTRACT

Systems, methods, and apparatuses are provided for tuning a mass spectrometer. An optimization process can be performed to determine optimal parameters for various physical parameters of elements of the mass spectrometer. A cost function (metric) can be defined for optimizing a measured signal output from the spectrometer. The metric can include an intensity term and a rectangularity term. The rectangularity term can provide a quantification of an extent that a measured signal corresponding to a first mass-to-charge ratio approximates a rectangle. The parameter values can be adjusted to find an optimal cost value of the cost function. Techniques may particularly useful when a quadrupole is operated in a broad-stability mode.

### CROSS-REFERENCES TO RELATED APPLICATIONS

This application is related to commonly owned U.S. Pat. No. 8,389,929 entitled “Quadrupole Mass Spectrometer With Enhanced Sensitivity And Mass Resolving Power” by Schoen et al., filed Mar. 2, 2010; U.S. patent application Ser. No. 14/263,947 entitled “Method for Determining a Spectrum from Time-Varying Data” by Smith et. al., filed Apr. 28, 2014; and concurrently-filed application entitled “Varying Frequency During A Quadrupole Scan For Improved Resolution And Mass Range,” the disclosures of which are incorporated by reference in their entirety.

### FIELD

The present disclosure generally relates to spectrometry, and more specifically to techniques for determining optimal settings for a mass spectrometer.

### BACKGROUND

A quadrupole is one example of a mass filter that can be operated such that ions of only a certain range of mass-to-charge ratios (also referred to as mass) are transmitted through the quadrupole. Such ions are considered to have a stable trajectory. Ions having a mass-to-charge ratio that is outside the stability range are filtered out. The stability range can be varied over time in a scan, thereby providing a mass spectrum over the scanned mass range.

An accuracy of the mass spectrum relies on knowing the correspondence between settings of mass spectrometer and a particular mass. The correspondence can be determined during the calibration process using a known sample. When the correspondence is not properly calibrated, one can incorrectly attribute detected ions to one mass when the detected ions actually have masses that are slightly smaller or larger than the one identified mass. As another example, the relative quantity of a particular ion can be inaccurate. For example, for a quadrupole, stability limits are set via applied AC and DC potentials, which can correspond to a particular mass. But, such settings of the AC and DC potentials can depend on settings for other elements of the mass spectrometer, even ones that do not vary during the course of a mass scan.

The determination of optimal settings can be difficult, particularly for complex modes of operation. One such complex mode is described in U.S. Pat. No. 8,389,929, which describes a broader stability range to increase sensitivity. Such techniques can include a deconvolution algorithm to quantify signals from various masses that may be stable at the same time. For example, temporal and spatial information at the detector can be used in the deconvolution process. Herein, such techniques are called broad-stability techniques or deconvolution techniques.

It can be even more difficult to tune settings of parameters when operating in a broad-stability mode. In particular, since a broad range of masses are detected at any one time, it can be difficult to look at the detected signal and visually determine whether one setting is better than another. Therefore, problems can ensue due to non-optimal settings.

Therefore, it is desirable to provide new techniques for determining optimal settings for parameters of the mass spectrometer that can address these and other problems.

### BRIEF SUMMARY

Embodiments of the present invention provide systems, methods, and apparatuses for tuning a mass spectrometer. An optimization process can be performed to determine optimal parameters for various physical parameters of elements of the mass spectrometer. In one aspect, embodiments are particularly useful when a quadrupole is operated in a broad-stability mode.

A cost function (metric) can be defined for optimizing a measured signal output from the spectrometer. The metric can include an intensity term and a rectangularity term. The rectangularity term can provide a quantification of an extent that a measured signal corresponding to a first mass-to-charge ratio approximates a rectangle. The parameter values can be adjusted to find an optimal cost value of the cost function.

Other embodiments are directed to systems and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1A shows an example quadrupole mass spectrometer 100 according to embodiments of the present invention.

FIG. 1B shows the Mathieu stability diagram in U, V space with a scan line and shows a mass spectrum as part of optimizing resolution of the mass spectrum according to conventional techniques.

FIG. 2 shows the Mathieu stability diagram with a scan line representing narrower mass stability limits and a “reduced resolution” scan line, in which the DC/RF ratio has been reduced to provide wider mass stability limits.

FIG. 3 shows a beneficial example configuration of a triple stage mass spectrometer system that can be operated with the methods of the present invention.

FIG. 4 shows a plot of a recorded data signal of total intensity for an array of voxels according to embodiments of the present invention.

FIG. 5 shows a diagram with a measured signal and a bounding box used for measuring signal rectangularity according to embodiments of the present invention.

FIG. 6 shows an optimization system 600 according to embodiments of the present invention.

FIG. 7 is a flowchart of a method for tuning a spectrometer according to embodiments of the present invention.

FIG. 8 is a plot 800 showing the values 810 for the row of matrix elements of matrix A and a superimposed triangle 820 according to embodiments of the present invention.

FIG. 9 shows a block diagram of an example computer system usable with system and methods according to embodiments of the present invention.

### DEFINITIONS

A “spectrum” of a sample corresponds to a set of data points, where each data point includes at least two values. A first value corresponds to a discriminating parameter of the spectrum, such as a mass or frequency. The parameter is discriminating in that the particles are differentiated in the spectrum based on values for the parameter. The second value corresponds to an amount of particles measured from the sample that have the first value for the parameter. For instance, a data point can provide an amount of ions having a particular mass-to-charge ratio (also sometimes referred to as “mass”). The sample can be any substance or object from which particles are detected, such as photons or sound waves scattered from an object or ions extracted from a substance.

A quadrupole mass filter (also referred to as an analyzer) includes four rods that are set parallel to each other. A “resolving voltage” refers to voltages applied to the rods. DC and AC resolving voltages are applied to the rods. The DC resolving voltage refers to a voltage signal of constant magnitude U (also referred to as DC amplitude) applied to the quadrupole (where two poles have a negative voltage and two poles have a positive voltage). The AC resolving voltage refers to a voltage signal of oscillating magnitude, e.g., defined as V cos(wt), where V is the AC amplitude and w is the oscillating frequency of the AC voltage. The AC voltages typically having frequencies in the RF range, and thus are often referred to as RF voltages.

A “scan” refers to a process of varying parameters of a mass filter. The settings of the parameters can be changed any number of times, with the settings being constant for one time period and changing from one time period to another. The settings may change at a particular rate. One or more parameters can change from one time period to another. During a scan, ions are detected are correlated to the settings for a particular time period so as to determine a mass spectrum. AC and DC voltages may be varied during a scan.

A “cost function” has an input of specific settings of parameters of the mass spectrometer. The cost function can be iteratively optimized (e.g., minimized) by selecting settings that result in a better cost value (e.g., higher or lower) of the cost function in a previous estimate for the settings. A “rectangularity term” relates to a transition of an ion not being detected to being detected by entering the stability region. The “rectangularity term” can provide a similarity measure of the signal to a rectangular bound box.

The term “optimal” refers to any value that is determined to be numerically better than one or more other values. For example, an optimal value is not necessarily the best possible value, but may simply satisfy a criterion (e.g. a change in a cost function from a previous value is within tolerance). Thus, the optimal solution can be one that is not the very best possible solution, but simply one that is better than another solution according to a criterion.

A “reference basis function” corresponds to expected spectrometry data for a particle with a given value for the parameter. For example, different reference basis functions would correspond to ions having different mass-to-charge ratios. Using more reference basis functions can provide greater resolution in the resulting spectrum. A reference basis function can include a set of voxels or voxel planes, where the elements of the set correspond to different time shifts.

### DETAILED DESCRIPTION

Signal resolution obtained during mass spectrometry can be improved by tuning the pass spectrometer. However, tuning can be very complicated due to the presence of many variables, and simple tuning processes can be imprecise. Embodiments of the invention provide novel techniques for accurately and efficiently tuning a mass spectrometer by posing the tuning process as an optimization problem (e.g., a convex optimization problem).

A cost function can be used as a measure for determining which settings are optimal relative to other settings. The cost function can include an intensity term and a rectangularity term, where the rectangularity term relates to a change in an ion not been detected to be detected by entering the stability region. In one embodiment, for each individual parameter, a setting that provided a signal with a maximum cost value based on intensity and rectangularity is identified. A relative weight can be provided between various terms of the cost function. This allows for complicated parameters to be tuned in a fast, reliable, and automated manner.

### I. Tuning a Mass Spectrometer

Various parameters of a mass spectrometer can be varied when tuning a mass spectrometer. Example parameters are provided below. And, some general aspects of optimizing parameters are also described.

A. Example Mass Spectrometer

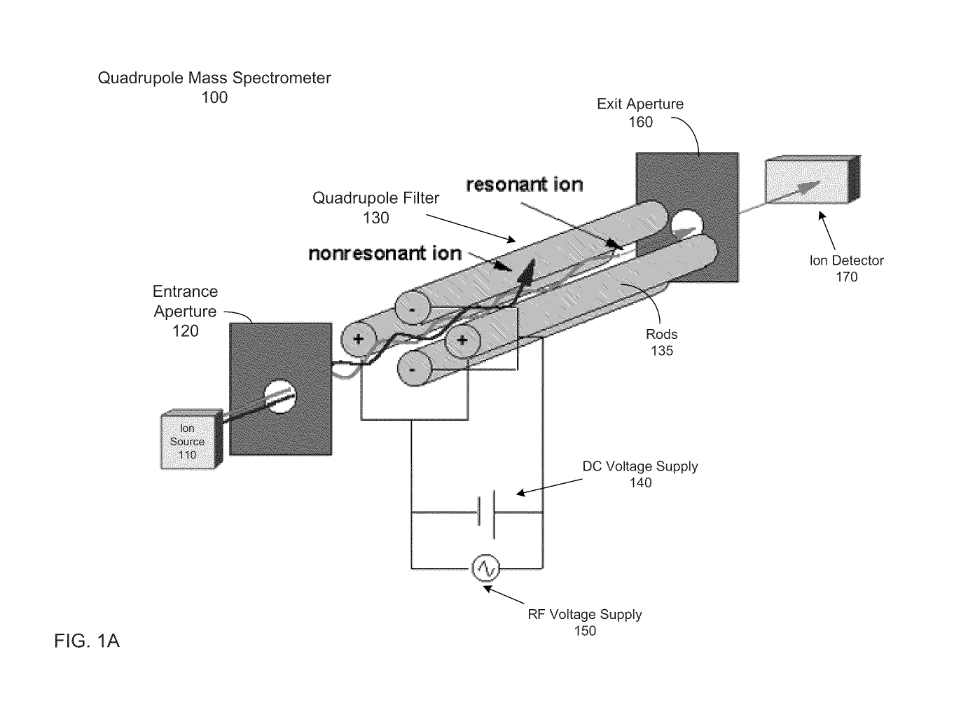

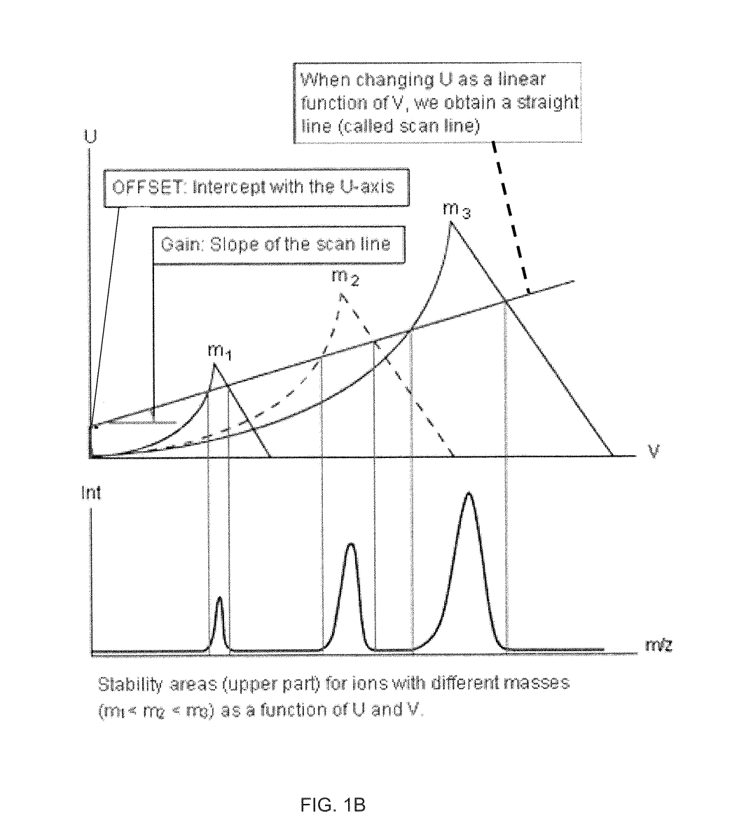

FIG. 1A shows an example quadrupole mass spectrometer 100 according to embodiments of the present invention. As shown, quadrupole mass spectrometer 100 comprises ion source 110, entrance aperture 120, quadrupole filter 130 with DC voltage supply 140 and RF voltage supply 150, exit aperture 160, and ion detector 170. Quadrupole mass spectrometer 100 can also include ion optics to accelerate and focus the ions through entrance aperture 120, detection electronics, and a high-vacuum system. An example length of quadrupole filter 130 is ¼ m long, and an example amount of energy for an ion exiting the ion optics is 10 eV per 100 amu.

Ion source 110 can have various parameters that affect the ion signal. The various parameters can differ depending on the type of ion source being used. Example parameters include sheath gas, spray voltage, capillary temperature, and capillary voltage.

Entrance aperture 120 or other ion optics can include various parameters to be optimized. For example, ion optics can include lenses that may have specified voltages for focusing and/or accelerating the ions.

Quadrupole filter 130 includes four parallel metal rods 135. Two opposite rods have an applied potential of (U+V cos(wt)) and the other two rods have a potential of −(U+V cos(wt)), where U is the DC resolving voltage and V cos(wt) is the RF resolving voltage (also referred to as an AC resolving voltage). The oscillating frequency w corresponds to how fast the AC voltage is changing,

The applied DC and AC voltage amplitudes and the AC oscillating frequency w affect the trajectory of ions, e.g., whether the ions travel down the flight path centered between the four rods 135. For given DC and RF voltages, only ions of a certain range of mass-to-charge ratios (also referred to as simply “mass”) pass through quadrupole filter 130 and exit aperture 160 to be detected by ion detector 170. Such ions are depicted as a resonant ion. Other ions are forced out of the central path and are not detected by ion detector 170. Thus, if the values of the DC and AC voltages are changed, different masses will pass through quadrupole filter 130, and will be detected by ion detector 170.

The applied DC and AC voltage amplitudes and the AC oscillating frequency w are other examples of parameters that can be optimized. These parameters may change with mass, whereas other parameters may stay constant during a scan. Relationships between DC and AC voltage amplitudes can also correspond to parameters. For example, a DC offset can correspond to the DC voltage when the AC voltage amplitude is zero. Another example parameter is a slope of the line that defines how the DC voltage and AC amplitude are increased.

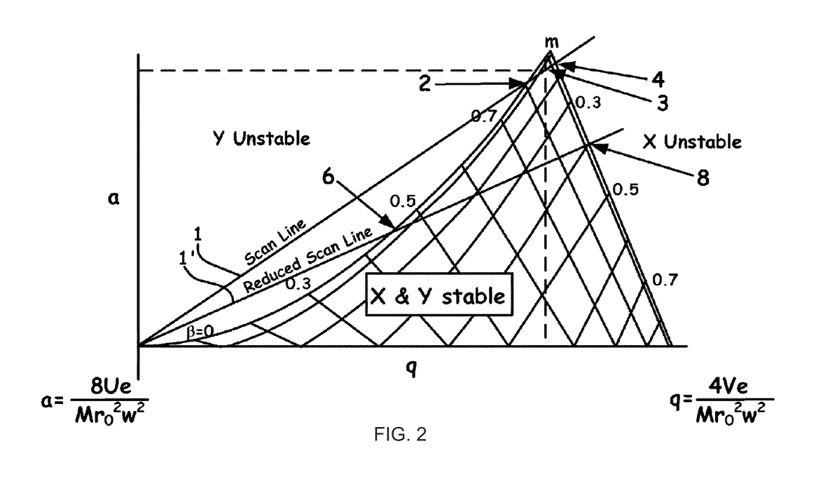

The resulting mass spectrum provides a measurement of a number of ions in a particular mass-to-charge ratio at any given instant in time. Typically, at any given time, only one mass-to-charge ratio is measured by having settings such that only ions of a narrow mass range have stable trajectories. However, to obtain greater sensitivity, embodiments can transmit a broader range of masses. Such techniques are described in more detail below with regards to the Mathieu equations with regards to FIG. 2.

B. Tuning for Signal Resolution

Mass spectrometers can be tuned in order to improve signal resolution. Tuning can adjust the parameter settings of a mass spectrometer such that a desirable peak shape may be obtained for a measured mass. For example, it is typically desirable to have a signal with a narrow peak.

Mass spectrometers can also be calibrated in order to measure certain masses as intended. Calibration refers to adjusting the parameter settings of a mass spectrometer such that mass measurement precision is improved. Calibrating a mass spectrometer can result in a shift in the subsequently measured mass-to-charge ratio values. Calibration can take place for a number of selected masses. If needed, masses can be added and removed from a calibration list.

Instrument tuning can maximize the resolution and intensity performance of the instrument. Tuning an instrument can include adjusting the DC offset values to adjust the intensity and resolution of calibrant masses (e.g., for quadrupole mode). The DC offset is the intersection of a scan line with the U axis (magnitude of the initial DC voltage for a scan), which, as known, can significantly affect the measured peak resolution. Gain is the slope of the scan function. A tuning procedure can be done with a calibration sample, e.g., that is stored in a vial in the mass spectrometer.

FIG. 1B shows the Mathieu stability diagram in U, V space with a scan line and shows a mass spectrum as part of optimizing resolution of the mass spectrum according to conventional techniques. The Mathieu stability diagram is the upper plot, and the mass spectrum is the lower plot. The peaks of the mass spectrum are shown when the scan line is within the Mathieu stability diagram for the corresponding mass. Each mass has a different Mathieu stability diagram.

Peak width can be set as a criterion for tuning the quadrupole mass spectrometer. If the peak width exceeds certain bounds, the resolution offset can be adjusted. For example, if the peak is too wide, the offset can be increased. If the peak is too narrow, the offset can be decreased. But, these two changes do not work when it is desirable have the scan go through a significant part of the stability region (i.e., not just the tip), as is described in the next section.

To optimize the resolution, the value of the DC offset can be adjusted for each selected mass so that it meets specified tuning criteria. When the offset is increased, the resolution increases as it will be nearer the top of the stability region. The width is typically measured at 50% of the maximum peak height. Conventionally, a smaller width corresponds to a higher resolution.

Intensity can also be a criteria used when tuning the quadrupole mass spectrometer. For example, the relative intensity can be specified when using a calibration sample. This can be accomplished by normalizing the width at half peak maximum such that the relative intensities correspond to the desired values.

Such tuning techniques can be acceptable for standard modes of operation. However such basic criteria of width intensity are not straightforward to use for broad-stability mode. The operation of such broad stability mode is now described in more detail.

### II. Temporal Resolution

In spectrometry, a device is commonly set to detect only particles having a single value for the discriminating parameter (e.g., mass or frequency) at any given time. For example, a mass spectrometer can be set to detect ions at a particular mass-to-charge ratio at a given instant in time. The settings of the mass spectrometer can then be changed to detect a different mass-to-charge ratio (sometimes referred to as just “mass”). To obtain high accuracy and detecting a particular mass, e.g., fractions of atomic mass unit (amu), then the mass spectrometer would have to be set to only detect a very narrow range of masses. However, using a very narrow range reduces sensitivity. Thus, embodiments can be set to detect particles having a relatively wide range for the discriminating parameter, thereby improving sensitivity. But, to maintain the resolution, a deconvolution process can be used to identify the signals corresponding to the different particles.

For example, embodiments of a high performance quadrupole system can use a deconvolution approach to extract mass spectral data from a sequence of multidimensional images produced by an ion detection system. An imaging system can detect ion trajectory details at the exit of a quadrupole mass filter and use that information to extract mass spectra at higher sensitivity and resolution than possible with a classically operated quadrupole mass spectrometer. The quadrupole is a mass dispersive technology and not just a mass filter. A software challenge is to extract mass spectra from this data in real time, which can be difficult since particles with different parameters are simultaneously being detected at a given instant in time. The particles may be detected on a two-dimensional grid (or other number of dimensions), which may be used in the analysis to discriminate among particles with different parameters. In some embodiments, particles may just be detected at various points in time, with no spatial resolution.

A. Spectrometry Data

As mentioned above, particles with a relatively broad range for the discriminating parameter are detected at any instant in time. The manner of controlling the range of particles can vary depending on the type of spectrometry data. For a quadrupole mass spectrometer, the range is governed by the Mathieu equation. For a particle to be detected, the trajectory along the quadrupoles needs to be stable in the X and Y directions that are transverse to the motion along the quadrupoles.

FIG. 2 shows such an example of a Mathieu quadrupole stability diagram for ions of a particular mass/charge ratio. The Mathieu equation can be expressed in terms of two unitless parameters, a and q, where a is proportional to a DC magnitude and q is proportional to an AC amplitude (also referred to as RF amplitude). The parameters a and q are unitless parameters that normalize the ion mass to charge ratio and system design parameters such as RF frequency and quadrupole field radius, as is well known in the art. Therefore, the Mathieu stability diagram is a mass independent representation of the a:q parameter space designating settings that yield stable ion trajectories. FIG. 2 shows a stable region in the middle where the trajectory is stable, an unstable region on the left where the trajectory is not stable in the Y direction, and an unstable region on the right where the trajectory is not stable in the X direction, where the X and Y directions are defined relative to the quadrupole rods. Only particles in the stable region will pass through the quadruple and be detected.

The operating scan line 1 is a set of values that are inversely proportional to mass. Different points on scan line 1 correspond to different masses. The masses that fall within the crosshatched stable region have a stable trajectory. As shown, masses on scan line 1 between entrance 2 and exit 4 are stable. The mass m corresponds to the mass at the peak 3 of the stable region. Having scan line 1 intersect at the top of the stable region causes a relatively narrow range of masses to have a stable trajectory, and thus be detected.

To detect different masses, a and q are changed in a predetermined manner. As these values change, different masses will have a stable trajectory. Conceptually, the peak of the stable region can travel along scan line 1, thereby causing a different mass (or relatively narrow range of masses) to be detected at different times, in conjunction with the progressive change in a and q. However, having a narrow range of detectable masses can decrease sensitivity.

A reduced scan line 1 provides a larger range of masses to be detected, as shown by penchant 6 and exit 8. This increase in sensitivity can come at the cost of a lower resolution, if the raw data was simply taken as is. To solve this problem, embodiments identify that different masses will enter the stable region at different times and exit the stable region at different times. Each mass exhibits a different pattern on the two-dimensional detector. As described in U.S. Pat. No. 8,389,929, a deconvolution can be used to identify contributions in the spectrometry data from particles with different masses. As described below, embodiments of U.S. patent application Ser. No. 14/263,947 provide improved analysis in determining a spectrum using values obtained for the deconvolution. The deconvolution can involve solving for a spectrum x in Ax=b, where A is the autocorrelation matrix of reference basis functions (e.g., each corresponding to a particular mass) and b is a cross-correlation vector that corresponds to measured data.

In other embodiments, the detector can acquire position in only one dimension, as opposed to two dimensions. Further, an exit phase of the particle can be detected to identify its position in three dimensions, e.g., by using the exit phase in combination with two-dimensional spatial resolution data. The range of the discriminating parameter for other spectrometry data can be determined in a different manner than described above for a quadrupole mass spectrometer. As other examples, the exit phase can be combined with spatial resolution data in one dimension to provide a position in two-dimensions, or the phase information alone can constitute a single dimension of data.

In one embodiment, just the exit time without phase information or spatial resolution can be used, e.g., just the detection time can be used with no spatial resolution. For example, the amount of particles being detected at any point of time would be a combination of the ions whose mass falls within the stable region. The various contributions from the different masses to the amount for each time period can be extracted, as is described below.

B. System

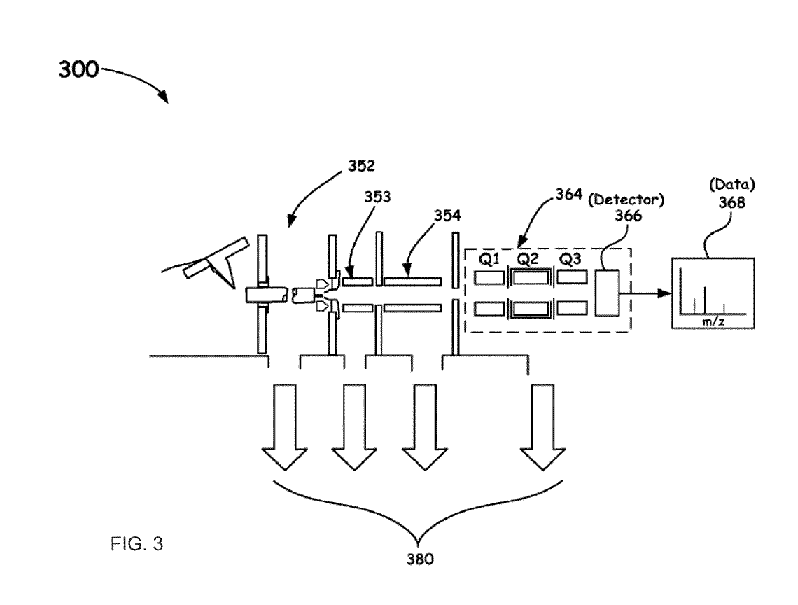

FIG. 3 shows an example configuration of a triple stage mass spectrometer system (e.g., a commercial TSQ). The operation of mass spectrometer 300 can be controlled and data can be acquired by a control and data system (not depicted) of various circuitry of a known type, which may be implemented as any one or a combination of general or special-purpose processors (digital signal processor (DSP)), firmware, software to provide instrument control and data analysis for mass spectrometers and/or related instruments, and hardware circuitry configured to execute a set of instructions that embody the prescribed data analysis and control routines of the present invention. Such processing of the data may also include averaging, scan grouping, deconvolution as disclosed herein, library searches, data storage, and data reporting.

A sample containing one or more analytes of interest can be ionized via an ion source 352. The resultant ions are directed via predetermined ion optics that often can include tube lenses, skimmers, and multipoles, e.g., reference characters 353 and 354, selected from radio-frequency RF quadrupole and octopole ion guides, etc., so as to be urged through a series of chambers of progressively reduced pressure that operationally guide and focus such ions to provide good transmission efficiencies. The various chambers communicate with corresponding ports 380 (represented as arrows in the figure) that are coupled to a set of pumps (not shown) to maintain the pressures at the desired values.

The example spectrometer 300 includes a triple quadrupole configuration 364 having sections labeled Q1, Q2 and Q3 electrically coupled to respective power supplies (not shown) so as to perform as quadrupole ion guides. The ions having a stable trajectory reach a detector 366, which can detect particles hitting the detector at any given instant in time. In some embodiments, detector 366 can also detect a position of an ion in one or more spatial dimensions (e.g., a position in a 2D grid). The 2D spatial dimension can be partitioned into different grid elements of an X-Y grid, where a grid element would be a smallest unit of resolution in the 2D grid. The spectrometry data can include an intensity at each location for each time step.

Such a detector is beneficially placed at the channel exit of quadrupole Q3 to provide data that can be deconvolved into a rich mass spectrum 368. The resulting time-dependent data resulting from such an operation is converted into a mass spectrum by applying deconvolution methods described herein that convert the collection of recorded ion arrival times and positions into a set of m/z values and relative abundances.

To detect a location, a lens assembly can be used, e.g., to detect spatial information and allow the use of the camera. Spectrometer 300 can include a helium cooling cell to produce a mono energetic ion beam to ensure each ion species produces a same set of images. Instrument parameters set to be invariant with ion mass can help provide uniformity for a set of images for any given individual mass-to-charge species across the mass range. The exit position and time of every ion can be recorded at a rate of several million frames per second.

In some implementations, a unit resolution of acquisition is a multidimensional representation of ion exit patterns. The unit can be referred to as a voxel or a volumetric pixel. Each voxel can correspond to a stack of image planes taken at a number of times (e.g., 8 or even just 1) spanning one quadrupole RF cycle. A voxel can include values from non-consecutive image planes, e.g., from different scans.

Each image plane corresponds to a different measurement at a different instant of time of intensities of ions hitting respective grid elements of the X-Y grid. Each voxel can correspond to a different grid element. The values of the planes for a voxel can be summed or a voxel can have an array of values. The number of planes in a voxel depends on how fast the images are being taken and the time of a cycle (i.e., how fast the RF device cycle time is). In one embodiment, the device would be scanned at the same rate for all samples. Fewer planes can reduce the data load per voxel to allow more voxels per second and therefore scan faster.

As an example, each plane can be a 64 by 64 pixel image, binned into 64 rows and 64 columns aligned with the quadrupole's x and y axes for a total of 128 readings per plane, as a compression of the 4096 pixels of the image plane. The binning can sum the values in a row and sum the values in a column, where some normalization could also be done. In this example, each pixel has a multichannel analyzer for the 8 sub-RF image planes that allows multiple RE cycles to be accumulated in a voxel.

A voxel plane can include the compressed 128 readings within a compressed image plane. A voxel plane can include any number of compressed image planes, including non-consecutive compressed image planes, e.g., from different scans. The image planes of a voxel or a voxel plane can include data taken with different machine parameters (e.g., different DC offsets and settings corresponding to different scan lines), where the image planes of a voxel or voxel plane may be taken sequentially or non-sequentially in time.

In the example using 8 planes for a voxel plane, each voxel plane would include 8 compressed image planes by 128 reading per compressed image plane or 1024 readings per voxel plane. The data throughput is therefore 143.744 megabytes per second when reading values are 16 bits. This amount of data can easily be handled by a 4 or 8 lane PCI express bus. Using 16 RF cycles for the binning and sampling process, 1.123 MHz RF results in exactly 70187.5 multidimensional voxel planes per second. A total value can be determined for a voxel plane or the voxels themselves, where all correspond to different ways to determine a total value for a total intensity for an array of voxels.

### III. Difficulties in Tuning

A goal of tuning is to achieve parameter values that deconvolve best and that best identify the exit position of each ion. Better deconvolution leads to higher resolution (e.g. better signal-to-noise ratios) and better quantization. This also allows for a more precise determination of values in the b vector (the cross-correlation vector), as the b vector can better approximate the true pattern of ions.

A number of physical parameters can be tuned on a quadrupole mass spectrometer, such as the a and q values, the number of RF cycles, a three-element ion lens set (e.g., which focuses the ion beam coming from a cooling cell) before the quadrupole for adjusting the focal position, various lenses for adjusting the amount of time ions spend in a fringe field, the extraction energy out of the cooling cell, a cooling cell offset, a cooling cell RF voltage, and a cooling cell drag field.

In a standard triple quad system, tuning can be accomplished with a DAC (digital-analog converter) scan. In a DAC scan, one element is changed at a time, and the quadrupole can have the a and q values set to be at the top of a peak for the mass being used for tuning. For example, a calibration sample can be known to yield ions of a particular mass. For initial settings of various parameters, U and V can be scanned to identify the peak for the known mass. Then, each element of the spectrometer can be optimized to increase the peak intensity. The scan line and offset of U,V can be optimized to provide a desired resolution, e.g., by optimizing a peak width and half maximum.

Such conventional optimization can be problematic for new systems, particularly for broad-stability techniques, where settings are not as established and/or where the system is more sensitive to differences in settings. For example, with broad-stability techniques, there is not a well-defined peak any more, and thus it is difficult to determine a good setting. Further, conventional optimization assumes similar behavior at other masses, and thus one just needs to optimize for a specific peak. But, in broad-stability techniques, the system can be more sensitive to small errors in the settings, and thus more likely to provide different behavior at different masses when optimal settings are not used. Such problems can also arise in normal operation (i.e., not broad-stability) when high accuracy is desired.

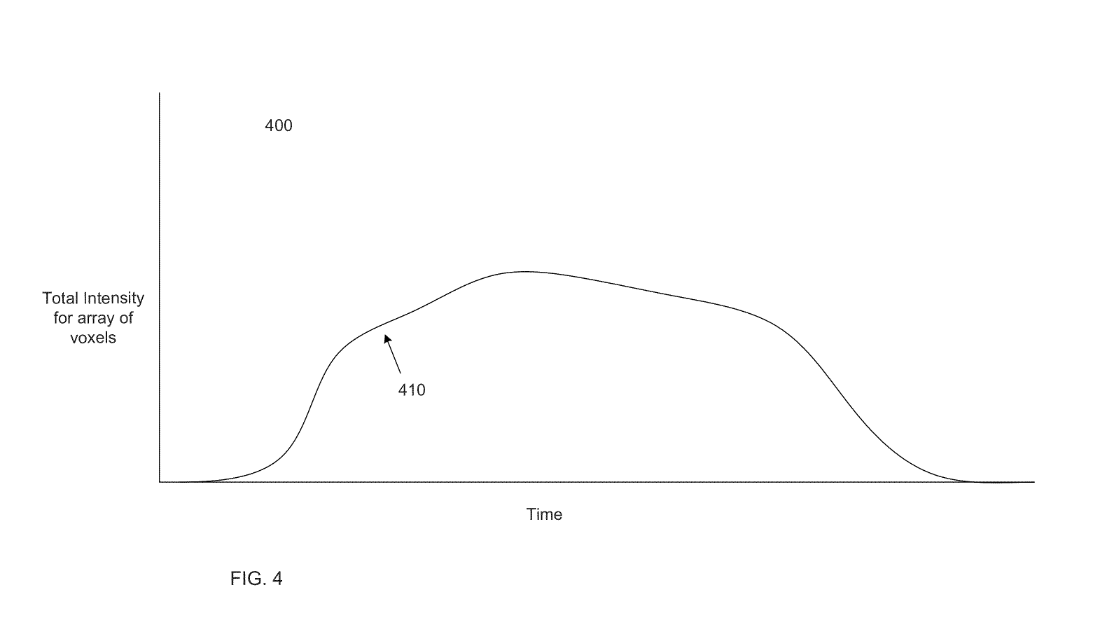

FIG. 4 shows a plot 400 of a recorded data signal 410 of total intensity for an array of voxels according to embodiments of the present invention. FIG. 4 can illustrate difficulties in tuning the spectrometer. The vertical axis corresponds the intensity for an array of voxels (e.g., total intensity or average intensity), and the horizontal axis corresponds to time points within a scan where, under conventional operation, each time points would correspond to essentially a single mass. The time of the scan can be specified in number of RF cycles applied to the rods of the quadrupole. A complete recorded data signal can include data for each X-Y grid element.

As mentioned above, the ions are recorded on a two-dimensional grid, where a voxel is the multidimensional data corresponding to where ions arrived in a two-dimensional grid within a given time unit (time window), and may include multiple data points for each image plane taken at a different time in the time range. The intensity for the array of voxels (e.g., determined from a voxel plane or the voxels themselves) corresponds to an accumulation of ions during a specified time unit for all points within the multidimensional grid. Thus, if we sum up the values from all of the grid points for all planes within the grid points, a single value can be obtained for each voxel plane for a unit time. The accumulated value during a unit time can be obtained from a plurality of measurements during a scan, each measurement for a different time, as described above. The accumulated value can be a total across voxels, an average across voxels, or other such values. Then, the accumulated values can be plotted across a range of times. FIG. 4 is such a plot.

Although depicted as a continuous line, recorded data signal 410 would be a series of data points. Each data point corresponds to the intensity for a particular voxel plane accumulated over one or more image planes during a unit time (e.g., over a microsecond). The set of data points show the change in intensity for a series of voxel planes over a time range. Each point in time can correspond to a different a-q value, and thus would conventionally be considered as different masses. As one can see, the recorded data signal 410 is not a sharp peak, and thus would normally be considered to be of very poor quality in a conventional tuning process.

Accordingly, for broad-stability techniques, what it means to have a good peak shape is no longer obvious or even knowable by human intuition. This presents a challenge unlike those previously encountered with quadrupole mass spectrometers. For broad-stability techniques, the inventor has identified that in order to tune for broad-stability, an entire monoisotopic peak (i.e. signal for one particular mass) should be scanned across (in a-q space) to identify what information content is in the peak (e.g., based on all of the voxel planes comprising the peak). The entirety of peak, including the sub positional information, can be measured. This is an important difference compared to doing a DAC scan in an element-by-element process in a standard triple quad system with the quadrupole having one a-q setting at the top of a peak.

### IV. Metric

In order to solve these problems, a metric (cost function) is defined and targeted to be optimized (e.g., maximized). The cost function can have a single value that is optimized. Thus, in one embodiment, if the metric is larger, better deconvolution results can be obtained (e.g., better results for the final solution of AX=B), along with better resolution. The metric can be optimized using a calibration sample having a specified mass.

The metric M can have various terms, each representing a different property of the detected signal. An intensity term I provides a measure of a quantity of ions of a particular mass. A rectangularity term S corresponds to a shape of the detected signal over time (i.e., over a scan or subrange of a scan of a and q). Specifically, the rectangularity term S is a measure of how similar the detected signal for the given mass relative to a rectangular wave, to which a square wave is a particular type. For example, by using the rectangularity term S, one can maximize flatness of a top of a peak while looking at transmission intensity simultaneously. Another example term is a resolution term R that is a measure of the ability to resolve one mass from another using the autocorrelation matrix A, which is determined using the reference basis functions determined at a particular setting. Thus, R is a function of A, and R can be determined in various ways.

Accordingly, the metric M can be defined as:

M=I^{a}×S^{b}×R(A)^{c}

The exponents a, b, and c provide a weighting scheme of the various terms. In various embodiments, such a metric can be used for tuning and using broad-stability techniques or for just a standard quadrupole tune-up.

As mentioned above, settings of various parameters (e.g., of various elements of the spectrometer) can affect the metric. The values of the various parameters can be searched (changed) to identify an optimal value of the metric. Various optimization algorithms can be used, as is described in more detail below.

A. Intensity I

For a particular group of settings (i.e., values for elements of the spectrometer), an a-q scan can be performed using a calibration sample of known mass. The scan can be over a range of a-q values for which the known mass should have a non-zero detected signal. For each scan, a set of intensities can be obtained (e.g., plot 400). The intensity value I can be determined using the intensities of the voxel planes or voxels across the scan.

As examples, the intensity term can correspond to the total intensity for all of the voxel planes over the entire scan or correspond to an average intensity for the voxel planes. One skilled in the art will appreciate that other values can be used, such as a median intensity of the maximum intensities for each voxel for a unit time. Accordingly, the intensity term I can provide a measure of a quantity of ions of a particular mass that are detected. Thus, the intensity term I can be maximized, regardless of the specific matter for determining the intensity term I.

By increasing intensity, more ions are detected. More detected ions provide more statistics and therefore better deconvolution. Given that the ions are detected across a time range, embodiments can assume that the ion source provides a substantially constant stream of ions. The intensity, I, of metric, M, may be weighted by raising to an exponent of any suitable value, such as 0.5, 0.65, or 1.5. The exponent used for weighting the intensity term can depend on how much the quality of the final deconvolved spectrum improves as intensity increases.

B. Rectangularity S

During a broad-stability scan, ions with a particular mass have a stable trajectory for a significant amount of time. Thus, during the scan, ions with a particular mass are initially in an unstable region (i.e., not detected); then the ions can enter a stable region, which can last for a specified amount of time; and then the ions can exit back into another unstable region (i.e. transition back to not being detected). If the spectrometer is tuned well, the transitions from unstable to stable (and stable to unstable) will be abrupt (e.g. sharp).

The sharpness of the transitions can be used in tuning the spectrometer. The sharpness of the transitions is captured in a rectangularity term S, which is a similarity measure of the signal to a rectangular bound box, and not just a square. The sharpness of the transitions can affect how well the deconvolution can identify particular masses. Accordingly, if tuned well, there should be no signal in the beginning (unstable region), then there should suddenly be a full-strength signal (stable region), and finally it should suddenly drop back to no signal (unstable region). In other words, the shape of the peak should approach square-shaped.

In order to capture all relevant information, a scan should be started before any signal is detected for a region of interest. Thus, if a peak is less like a square (e.g. a peak with a longer tail), then a larger scan range needs to be used. This means that a longer amount of time will be used to scan a small window. The long tail can cause deconvolution to put small values where they should be optimally zero, which can make the deconvolution worse.

The sharpness of a signal can be particularly problematic for broad-stability techniques. For example, in broad-stability techniques, fewer RF cycles may be used than in typical operation. Fewer RF cycles may result when the spectrometer operates at higher ion kinetic energies while maintaining the same RF frequency so as to keep the number of RF cycles the same. This is not as much of a concern for conventional techniques, where there are about 200 RF cycles and there is 10 to 20% energy spread, since the energy spread gets washed out with the high RF cycles. And, in conventional techniques, there is no need to keep RF cycles the same, and thus where the stability starts and ends is not as critical.

RF frequency can also decrease to keep the number of RF cycles the same, as is described in concurrently-filed application entitled “Varying Frequency During A Quadrupole Scan For Improved Resolution And Mass Range.” These situations can lead to slow transitions (e.g. a fuzzy edge) and a peak shape that is less square-like. Slower transitions can also occur due to the scan line being lower in the stability region, i.e., not just at the peak.

The fuzzy edges can occur because a stable-unstable transition can include masses that are on the fringe between stable and unstable, or just barely unstable. An ion that is barely unstable will actually continue to travel down the filter for some time before colliding with a quadrupole or otherwise exiting the filter. The ion will not be ejected until it undergoes a certain amount of RF cycles, and this will take a certain amount of time. Accordingly, in normal operation where a high number of RF cycles is used, ions on the stable-unstable border will still be ejected, and the border edges in the a,q space will be sharp. However, in broad-stability techniques with fewer RF cycles, some marginally unstable ions may actually pass completely through the mass filter, causing fuzzy edges and a less square-like peak shape.

In some embodiments, to determine the rectangularity term S, a bounding box can be used. The similarity of the measured signal to the bounding box can be used as the rectangularity term S. For example, a percentage overlap between the measured signal and the bounding box can be used, where a larger value means that the signal is more like the box. Using I and S in combination can provide an advantage of targeting transmission with sensitivity to the flatness of the top of the peak with regards to a known instrumental stability such that maximum transmission and minimized instrumental error are coupled into measurements.

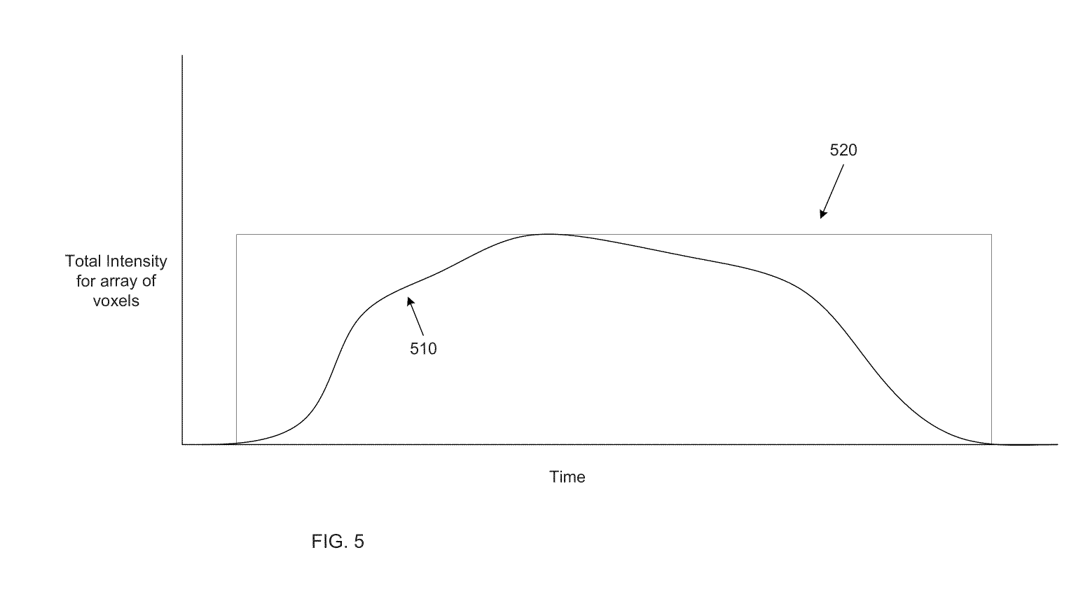

FIG. 5 shows a diagram with a measured signal 510 and a bounding box 520 used for measuring signal rectangularity according to embodiments of the present invention. The vertical axis is intensity and the horizontal axis is time, as for FIG. 4. The measured signal 510 can take on various forms, e.g., a total intensity across voxels, an average intensity across voxels, etc. Thus, measured signal 510 can be the same as recorded data signal 410.

In FIG. 5, the left edge of the bounding box 520 is located at the point where the signal 510 first exceeds a threshold value, and the right edge is located at the point where the signal 510 drops below the threshold value. The threshold value can depend on the noise within the system, and thus relate to a baseline value. For example, if the detected values randomly vary within a certain range, even at a time far from the position of the true signal, then a maximum of that range could be used as the threshold (e.g., 2 times the typical range of noise). The threshold for determining the edges of the bounding box around measured signal 510 can be based on signal 510 itself. For example, the threshold could be taken as a particular percentage of the maximum (e.g., 1% or 5%). Thus, the smallest parts of the leading and trailing edges of the signal could be ignored.

The top of the bounding box 520 is at the top (peak) of measured signal 510. Thus, measured signal 510 is completely within bounding box 520, except for noise that might occur before and after the true signal. Thus, a perfectly square signal would fill up the entire bounding box. The rectangularity term, S, can measure the similarity of measured signal 510 to bounding box 520.

In some embodiments, the rectangularity of the signal 510 can be defined by calculating the percentage of bounding box 520 that is filled by measured signal 510. The percentage is equivalent to a fraction of fill. Regardless of how the rectangularity term is calculated, a weighting exponent can be used (e.g., ¼).

C. Resolution R

As mentioned above, the resolution term is dependent on the autocorrelation matrix A. When the spectrometer is tuned properly, the measured signal for a particular mass can be resolved from the measured signal for another mass. A different autocorrelation matrix A would be determined for each group of parameter settings, since a different measured signal would be obtained for a calibration sample having a known mass. Thus, for each group of setting, a new autocorrelation matrix A would be determined, and then a resolving power of that matrix A can be determined to provide R.

### V. Determining Parameters

In some embodiments, the determination of the parameters can be automated. For example, a computer system can control the settings of the plurality of elements of the spectrometer. For a given group of settings (also referred to as a multi-dimensional setpoint or just setpoint), the computer system can receive the measured signal and determine the corresponding metric. The computer system can determine metrics for various multidimensional setpoints, and identify an optimal setpoint that provides an optimal metric (cost value). Various optimization techniques can be used.

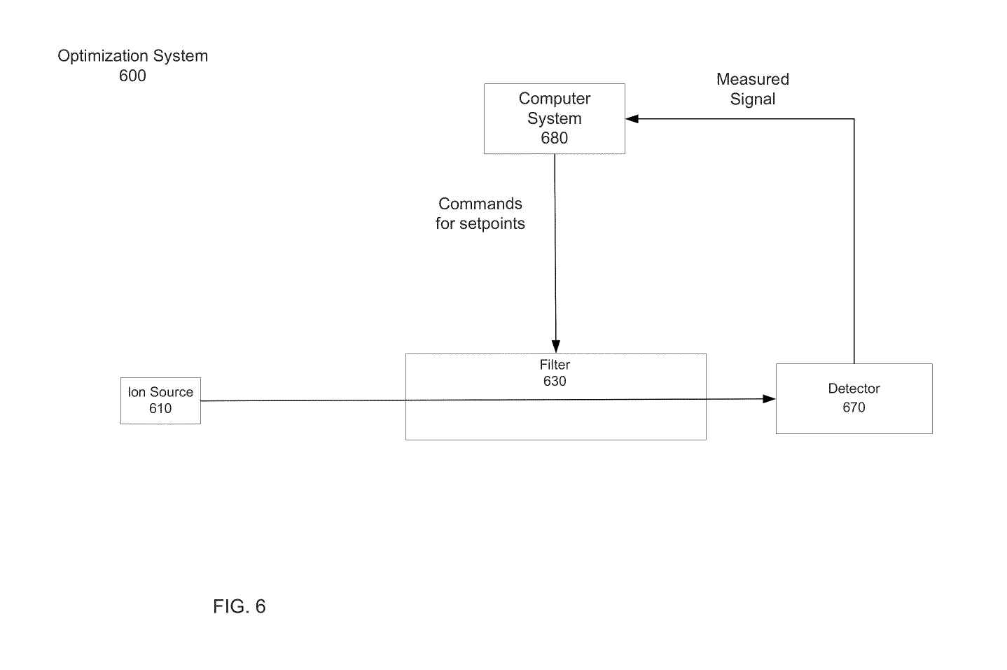

FIG. 6 shows an optimization system 600 according to embodiments of the present invention. A mass spectrometer is shown to include an ion source 610, a mass filter 630, and a detector 670. Mass filter 630 can include various power supplies, e.g., a DC power supply and an AC power supply, both supplying power to the rods of the quadrupole. Computer system 680 is communicatively coupled to the mass spectrometer, and specifically coupled to mass filter 630 and detector 670. The connection to a mass filter 630 can provide commands for changing setpoints. For example, the commands can change any AC or DC voltage, change lens settings, and any other change to a variable element of a mass spectrometer that can be tuned. Computer system 680 can receive a measured signal from detector 670, and use a measured signal to determine a metric for the current settings (setpoint).

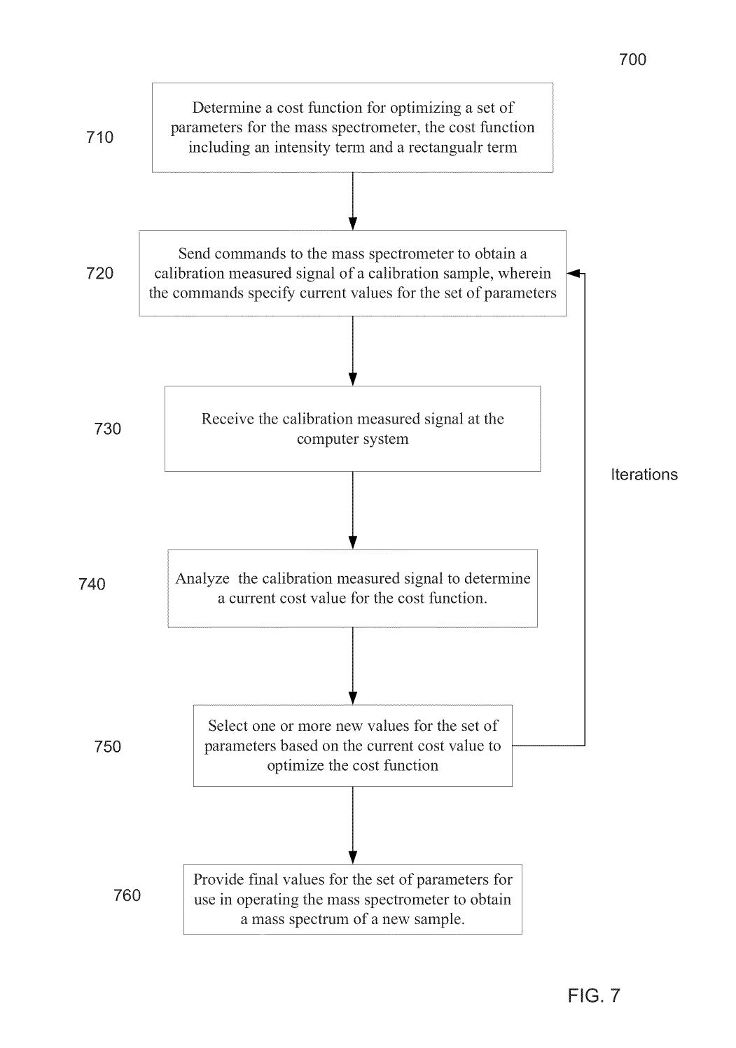

FIG. 7 is a flowchart of a method 700 for tuning a mass spectrometer according to embodiments of the present invention. As mentioned above, method 500 can be performed by a computer system that is communicatively coupled to the spectrometer.

At step 710, a computer system may determine a cost function for optimizing a set of parameters for a mass spectrometer. Herein, the cost function is also referred to as a metric. The cost function can be determined, e.g., by reading input from a file or from input provided by a user via a user interface. For example, the computer system can read input identifying terms to be used in the cost function. The input can also include a specification of particular settings (e.g., convergence criteria or weighting exponents) and/or algorithms to be used to calculate each of the terms.

Each parameter corresponds to a different tunable element of the mass spectrometer. For example, one parameter can be voltages on metal discs of an ion lens. The cost function includes an intensity term and a rectangularity term. The rectangularity term is a quantification of an extent that a first measured signal corresponding to a first mass to-charge ratio approximates a rectangle. As an example, the rectangularity term can be determined as described above.

In one embodiment, the cost function (metric) used is the following:

M=I×S¼×R(A).

I is the intensity. S is the rectangularity of the measured signal for a particular mass, which can be measured by putting a bounding box from baseline to baseline on the peak transmission and calculating the filled fraction of the bounding box, as is described above. In some embodiments, a resolution term R(A), which is dependent on the autocorrelation matrix A, can be used. In the example above, the rectangularity term is weighted by an exponent of ¼, which increases the term when the rectangularity term is determined as a fill fraction, and thus decreases the effect of changes. The other terms have a weighting exponent of 1, but other values could be used such as a weighting exponent of 0.6 or 0.7 for the intensity, or an exponent having a value between 0.6 and 0.7.

Then, a plurality of iterations of an optimization process may take place, and each iteration may include steps 720-750. The plurality of iterations can use the cost function to determine optimal values for the parameters. An iteration can analyze one or more setpoints for the parameters, e.g., an iteration can analyze multiple sets of values of the parameters, and then determine an optimal value or new sets of values of the parameters for a next iteration based on the cost values of the multiple sets.

At step 720, the computer system sends commands to the mass spectrometer to obtain a calibration measured signal of a calibration sample. The calibration sample can contain ions of only one particular mass, therefore the calibration measured signal should predominantly be ions of a particular mass. In other embodiments, the calibration sample can include ions of various masses, but where the masses are significantly different so that their respective measured signals do not overlap. The calibration measured signal includes a first measured signal for a first mass being used in the optimization process. The calibration measured signal can include other respective signals for other masses, e.g., when a calibration sample includes ions of multiple masses.

The commands specify current values for the set of parameters. For example, the commands can specify that a particular parameter is to have a particular value. The values of other parameters can stay the same as default, or the commands can specify the other parameters to be the same, or even specify the same values as a previous iteration. The commands can also include a stack command to begin measuring a signal with the current values for the set of parameters.

At step 730, the computer system receives the calibration measured signal. In one embodiment, the computer system can receive calibration measured signal as a stream of data. For example, once a computer system sends a start command to the spectrometer, the computer system can open up a communication channel with the detector to begin receiving the measured signal. In one implementation, the spectrometer can provide an end signal to the computer system, so that the computer system can stop gathering of the measured data signal.

At step 740, the computer system analyzes the calibration measured signal to determine a current cost value for the cost function. The analysis can include determination of any terms of the cost function, such as the intensity term and the rectangularity term. Thus, the current cost value can include contributions from the intensity term and the rectangularity term. The determination of other terms would also be performed. Then, the calculation can be made using all of the terms, e.g., using weighting exponents and multiplying the resulting terms.

At step 750, the computer system may select one or more new values for the set of parameters based on the current cost value to optimize the cost function. The one or more new values can be used in a next iteration, such that the new values are included in new commands sent to the mass spectrometer for the next iteration. For example, five sets of new values can be determined, or some other number of sets, where a cost value is determined for each set of values. At least some of the new values can be different than the values used in the previous iteration, but some of the new values can be the same as the values used in the previous iteration.

At step 760, the computer system provides final values for the set of parameters for use in operating the mass spectrometer to obtain a mass spectrum of a new sample. In one embodiment, the final values can be determined once the optimization process satisfies particular convergence criteria for the cost value. For example, a change in the cost value may be sufficiently small (i.e., less than a cutoff), and then the final set of values would correspond to the last set of values used. In another embodiment, a predetermined number of iterations may be performed. The final values can correspond to the tune values for the spectrometer. Thus, the final values can be used in production runs for analyzing new samples. The measured signals for the new samples can be received and deconvoluted to obtain a mass spectrum for the new sample.

### VI. Determination of Resolution Term R(A)

Embodiments use various properties of the autocorrelation matrix A to determine how well one mass can be resolved from another mass. The resolution term quantifies the extent of how well one mass can be resolved from another mass. As described in U.S. Pat. No. 8,389,929 and U.S. patent application Ser. No. 14/263,947, A is an autocorrelation matrix determined from the calibration measured signal obtained from the calibration sample. The resolution term R(A) may be particularly important for broad-stability techniques.

A matrix element of A can correspond to an integral of the product of two reference basis functions, where a reference basis function corresponds to a particular mass. As the various reference basis functions will exhibit a same pattern, but shifted over time, the reference basis functions can be determined from the first measured signal that corresponds to a particular mass. In other embodiments, multiple individual signals corresponding to different masses can be used, e.g., the time shift is not linear. Such different individual signals would correspond to masses that are relatively far apart from each other in time, as a time shift would typically be linear within a nearby region. In one embodiment, the reference basis functions can depend linearly in time and exponentially in mass.

Accordingly, A can be computed using the signal measured for a given setpoint of parameter values. To do an autocorrelation for a single mass, the entire a-q space is scanned for a single mass. This collects the set of two-dimensional images that is needed for that particular mass. For example, one can obtain 100 images, each corresponding to 100 different pairs of a-q values for a given mass. The measured signal for that given mass can be used to create a reference basis function for a range of masses, and then the autocorrelation matrix A can be determined.

The autocorrelation matrix A is a circulant matrix, where each row is a shifted version of the previous one. Ideally, the correlation of the reference basis function with itself would be significantly different than the correlation with another reference basis function, as a greater difference would result in it being easier to assign data to one mass as opposed to another, which is part of the deconvolution process. In this manner, the information included in the set of voxels of voxel planes covering an a,q space, which is then used to form an autocorrelation matrix A, can include more information, and thereby provide better accuracy.

There are a number of different techniques for calculating R(A). In one technique, R(A) is calculated by determining what significance the deconvolution technique places on differences between a correlation of adjacent reference basis functions by the present set of voxels or voxel planes. Alternative options can be used to maximize other parameters, such as desired final resolution or maximizing the final area accuracy. Another option is to use a Monte Carlo type simulation of randomized basis functions to determine the resolution or accuracy of the final solution. The different techniques can use different amounts of computer time to execute.

A. Differences in Matrix Elements of a within a Row

In some embodiments, the matrix elements of the autocorrelation matrix A can be analyzed. And, more specifically, the values of matrix elements can be analyzed. For example, the change in the values of a row of the auto-correlation matrix (a circulant matrix) can indicate how well A can resolve mass. A larger change between matrix elements provides greater resolving power, as this indicates that the signals from one mass to another (i.e., the reference basis functions) are more different. This greater difference allows for greater accuracy in resolving ions from one mass to another in the deconvolution process.

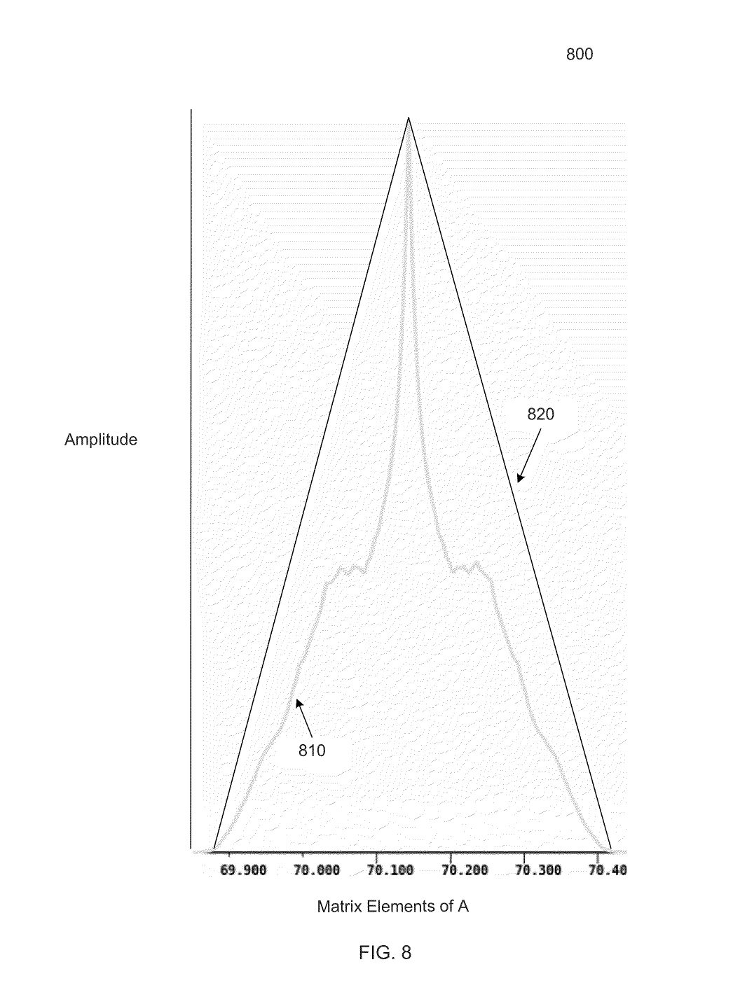

FIG. 8 is a plot 800 showing the values 810 for the row of matrix elements of matrix A and a superimposed triangle 820 according to embodiments of the present invention. The horizontal axis corresponds to different matrix elements of one row of matrix A. The horizontal values correspond to a relative time shift in a row of the autocorrelation matrix A. The autocorrelation values of a row are determined from a reference basis function correlated with time shifts of itself. The maximum value in the plot corresponds to the time when the voxel set is aligned with itself and has no shift. This corresponds to a single row in the A matrix. In the event that the matrix is circulant, these rows are interchangeable with a separate start time. Although depicted as a continuous curve, values 810 would be discrete data points, with each data point corresponding to a different matrix element.

Since the matrix elements are of a particular row, the matrix elements are determined by a functional overlap (e.g., an integral) of each of the reference basis functions with a same reference basis function. The horizontal axis can also be considered to relate to time, as each of the reference basis functions are a time shifted version of each other. The maximum of the matrix element values corresponds to the diagonal elements of matrix A, as this is the correlation between a same reference basis function.

In one implementation, a difference is taken between two particular matrix elements, e.g., between third and 10^{th} matrix elements away from the maximum. This difference can be taken as R(A). As stated above, a larger difference between matrix elements allows for greater resolution accuracy. In one view, the greater difference creates a more narrow peak in the matrix elements. Note that this peak is not a measured signal, but of the matrix elements of the autocorrelation matrix A.

Other implementations can have more complicated analysis. For example, the difference between the values 810 and the triangle 820 can be computed. Triangle 820 corresponds to a bad solution, as a decrease in the maximum value is linear. Thus, a larger difference is preferred. Various differences could be used. For example, a fill fraction can be used or a sum of differences between the matrix elements in the triangle, which can include a sum of the square of the difference or sum of the absolute values of the differences. The fill fraction would include the sum of difference, when normalized by an area of the triangle. Such a sum could be normalized by the number of matrix elements and/or maximum amplitude.

Other functions besides a triangle could be used. Thus, the resolution term can include computing a sum of differences between the matrix element of the row and a specified function, wherein the specified function has a maximum value that coincides with a maximum value of the matrix elements of the row. Examples of other specified functions include any symmetric geometric shape that is normalized to the actual peak height of the matrix elements. The specified function can be required to be within the triangle. Thus, any piecewise linear shape can be used. For example, a normalized autocorrelation matrix that is known to be bad can be used. An autocorrelation matrix that is good also can be used, where a higher similarity to the good matrix provides a higher cost value, and a higher difference from a bad matrix provides a higher cost value.

B. Difference Between Auto-Correlation Matrices

As another example, two different autocorrelation matrices can be determined, and difference taken between them. A first cross-correlation matrix A1 can be determined for the voxels or voxel planes (e.g., multiples sums of voxels for a unit time) corresponding to the 2D array of the detector, and a second auto-correlation matrix A2 can be determined for just a point detection (e.g., all points of 2D array summed, and thus position information is lost). A good first auto-correlation matrix A1 should be different than the second auto-correlation matrix A2, e.g., because the use of just point data will not be able to resolve one mass from another.

Thus, one embodiment can take the full two-dimensional image sequence (for one mass) as a 2D reference basis function and calculate an autocorrelation for it. Then, the values for each point can be summed into one value per unit time (effectively taking the 2D pattern to a single point, such that it is now simply an intensity for a time slice) to obtain a single-value reference basis function, and an autocorrelation can be performed for that one value. The 2D in the reference basis function refers to a 2D array of values for each time period, and the single-value means that there is only one value (e.g., average) for each time period. This single-value autocorrelation loses the 2D spatial location on the detector, and thus can provide poor resolution when broad-stability techniques are used.

A difference can be computed between the two autocorrelation matrices. For example, an L1 or L2 norm difference can be computed between the two autocorrelation matrices. The selection of the norm difference can correspond to the same used in solving Ax=b to obtain a mass spectrum for actual samples. Using this method, rectangularity issues, intensity fluctuations, and much of the noise can be canceled out. Accordingly, this technique can be quite robust.

The larger the difference between the two autocorrelation matrices, the more information content there will be in the autocorrelation matrix using the 2-D images because the underlying shapes within the two-dimensional pictures have more information. If the point and the pattern are different, one can determine where the ion came out in space. If all the images look exactly the same, the two matrices would line up. Such poor resolution would also occur if one set the RF cycle count to around 200 or 300 cycles and stop cooling the ion beam (i.e., large energy spread), measured signals would look virtually identical.

C. Simulation with Random b and Solving Ax=b

In another embodiment, a cross-correlation matrix can be determined and can be used in a simulation to resolve simulated data to which a solution x is known. The closer the determined x is to the known answer, the better the settings are. The simulated data does not need to be physical data.

Accordingly, one implementation is to determine a reference basis function from the acquired data, and use the reference basis function to generate the auto-correlation matrix X. The matrix A can then be used to generate a large set of statistically random b vectors for various ions (e.g., simulated ion fluxes based on Poisson statistics). The simulation can be based on a specified distribution of ions that can comprise an expected x.

By performing the simulation, embodiments can determine how well both positional accuracy and area reconstruction can be resolved. Such a procedure can provide more flexibility than optimizing difference between two line shapes. Also, such a procedure allows optimizing for either positional accuracy or area.

In this method, b is statistically generated based on an A. The size of A can be smaller (e.g., about 100) than a full size that would be used in a production run (i.e., smaller mass range), or can be same as full problem. The number of statistical simulations needed to generate results with this method can be on the order of 100 random samples, each providing a randomized b vector. An advantage of this method is that one can optimize for specific results, such as resolution at the expense of quantitation. Additionally one can optimize for either low ion flux or large ion flux, as the randomized b vectors can be created using a particular ion flux from a simulated ion source. The optimization for ion flux can be performed when different signal shapes are better for different ion fluxes for the eventual ion source used in production.

In one embodiment, the statistically random cross-correlation b vector is created by creating statistically random voxels or voxel planes of a simulated measured signal based on the first reference basis function that was used to determine A. For example, embodiments can randomize the binned data of a compressed image plane (e.g., the 128 readings generated from the starting 4096 of the image plane) or randomize the 4096 values of the image plane. In another embodiment, the statistically random cross-correlation b vector can be varied directly. In one implementation, the random data sets are created by taking the measured data that is used to generate an A matrix, and then randomizing the data with a random number generator (e.g., a Poisson random number generator). This can give randomized data sets with the same statistical variations as the real data would have and allows for targeting certain ion flux levels.

Accordingly, one would solve for Ax=b for each randomized b vector, where the solution can be constrained to have non-negative values for x. Since b is determined from a simulation, one does not have to collect actual data across multiple masses, which might take a long time. But, there is still a need to solve Ax=b, which might be slow in practice. However, high accuracy can be obtained.

The resolution term R(A) can be computed as a specific measure of how close the computed mass spectrum x gets to the simulated masses used for the simulation. The larger the variation the result in x has for a simulated mass, either in position, resolution, or quantity, the lower the R(A) term will be. The variations (e.g., square of absolute values) can be summed across the vector to provide a single variation value.

### VII. Optimization Algorithms

As discussed above, a metric (cost function) can be optimized to determine tuned parameters for the spectrometer. The spectrometer can have multiple parameters to tune, and the parameters may interact so that changing one parameter can affect an optimal value for another parameter. One skilled in the art will recognize various optimization algorithms are usable with embodiments.

The parameters may not have a single maximum when considering all settings, but the parameter settings can be limited to a certain range that only has a single maximum. For example, empirical probing of random values shows that there are few regimes that the elements can be operated within, and each regime has a single maximum. Thus, regimes that are not realistic for the practical scans can be ruled out, based on knowledge of how it was intended to function, and a wide general range can be tested where there is only a single maximum of interest.

Accordingly, for a given initial range of possible values for a certain element (corresponding to a particular parameter), the best value can be determined. Within the initial range, several parameter values can be tested. The metric can be calculated using each test parameter value of the element that is currently being optimized. The best parameter value for that element can correspond to the one that provides the highest value for the metric, e.g., within a tolerance range. The cost function could also be defined to provide an optimal solution for a minimum.

In some embodiments, the cost function can be defined so that all elements have a single maximum, at least within a known range of operability. The cost function can also have a global optimum that can be achieved by piecewise walking each element towards its own metric optimum. Also, in some implementations, it can be assumed that iteratively walking each element after the others are optimized will eventually converge on an optimal mode of operation.

A. Search

In some embodiments, each element can be optimized one at a time without having to consider the rest of the system. For example, parameter values for one element can be tested and an optimal value can be identified. Then, the process can be restarted for a different element to find the maximum for that element as well.

In one implementation, a search tree process can be used to iteratively optimize each element. Based on the assumption that each element has a single maximum parameter value, embodiments can sample discrete points on a graph with subsequent division of the parameter space in order to find the maximum for a particular parameter. Such a method can find a maximum regardless of differentiability or smoothness of the line shape. It allows a peak to be found without having to sample a large number of points, as a range is iteratively sampled and narrowed.

Accordingly, for a particular parameter, an initial range can be specified. For this initial range, a specified number of parameter values can be used to obtain cost values for each parameter value. For instance, assuming the parameter values are between 0 and 100, five parameter values can be taken at 0, 25, 50, 75, and 100. The number N of specified values can vary, and does not need to be an odd number, although using an odd number can allow re-use of cost values from a previous iteration.

A highest value or set of M values of the N cost values can be determined, and this value or other value (e.g., median, mean, or mode) of the set of M values can be taken as a midpoint for a new range of values, e.g., which is 50% smaller than the previous range. For example, if the cost value at 50 was the highest out of the five cost values, then the new range can be between 25 and 75. If 25 was the highest, then the new range could be between 0 and 50. Or, if 50, 75, and 100 were the three highest cost values, then the new range can be between 50, 75, and 100. If the subset M of the N cost values are not contiguous, then N can be increased, the subset can use a third value contiguous with the highest other two values (or other values when different values is used for the subset), or other steps can be taken to resolve the problem. M is less than N.

Assuming that the cost value that is associated with the parameter value of 50 was the highest, the new range can also be split into five equal intervals by bisecting the interval between 25 and 50 and the interval between 50 and 75. The process can then repeat, with the range decreasing by half at each iteration.

In some embodiments, the optimization for a single parameter can proceed a specified number of iterations. The number of iterations may depend on the accuracy that one can set the parameter, as one does not need to optimize to a greater accuracy than one can set the parameter itself. The number of iterations can be enough to get the parameter within a certain threshold. For example, embodiments can identify a point with

$$N = 5 + 2 \times {log}_{2} \frac{R}{4}$$

measurements needed to achieve any power-of-two resolution within the original parameter space identified. In practice, this means 17 measurements can narrow the parameter space surrounding the optimal set of parameter to within 1/256 of the original space. Thus, a certain level of predictability can be achieved for the amount of time that it takes.

In other embodiments, the process can also finish once a flat peak is reached. For example, if the cost values at each point are within a threshold, the peak is considered found and the process can stop. Multiple values could be within a tolerance, and any of those values can be considered optimal.

After determining the optimum value for the first element, the process is repeated for the next element. When performing the search for a new element, the optimal values for each of the previous elements are used. Repeating this flow, all elements can be optimized in turn, producing a full set of optimum values (i.e., can optimal value for each element).

The optimization process can repeat entirely. Each optimization process can start with the same initial element value ranges or with a truncated range. This repeating can address the interaction between parameters. For example, an element with a lot of variation may start again with the original (previous) full range, while an element without much variation may have the original initial range reduced by some percentage amount (e.g., 30% or 50%). The variation can be measured as a relative or absolute change among values in the interval range. The variability can be required to be less than a threshold for multiple optimization processes for the range in a next optimization process to be truncated. Historical data from other measurements can also be used to determine the variability for a given parameter.

A certain number of optimization processes (outer iterations) can be performed, or a convergence threshold can be used for the resulting cost values of the outer iterations. Practically, three to give outer iterations has been found to be suitable. Accordingly, for 8 parameters, the number of inner optimization iterations is about 8×5×17, where each inner optimization iteration would occur using N specified points (e.g., 5). A smaller number of iterations can be achieved using truncated regions on later outer iterations.

As an example, although all of the eight different elements can be optimized, only one will be searched at a time. The algorithm can start with one element, and can choose several (e.g., an odd number) points within a preset range (e.g. 0 to 100 Volts) for the element. For example, the algorithm may select five evenly spaced points along some predefined parameter bounds, which may have already been determined. There may be some initialization criteria for determining the in-between points, which do not have to be midpoints.

Then, the value of the metric is measured for each of the points, and the largest of the five measured values is identified. After that, the point (e.g. 40 Volts) corresponding to the largest value, and the two adjacent points (e.g. 20 Volts and 60 Volts) are used as the initial three points in the next round of parameter refinement. The two adjacent points are used as the outer bounds in the next sequence. The process repeats the sequence by adding in two additional points (e.g. 30 Volts and 50 Volts) within the newly narrowed range, and takes measurements for the two new points, thus having another set of five measurements. This process is repeated until the desired accuracy of the parameter is achieved or the values are otherwise indistinguishable. The element is then kept at this optimized setting.

B. Other Techniques

In addition to the search tree algorithm, there are several other methods for optimizing the elements. For example, a large number of points (e.g. N points) can be measured, and the point with the largest metric value can be chosen. Other embodiments can use gradient techniques, where a gradient can be determined by sampling points. The step distance from a currently-measured point to the next point can be based on the local gradient. For example, three sample points can be measured, and it can be determined which direction is ascending and which is descending. Sampling can progress in the ascending direction until the maximum is located. Newton optimization techniques can be used to build up a Hessian matrix. Genetic algorithms can also be used.

### VIII. Computer System

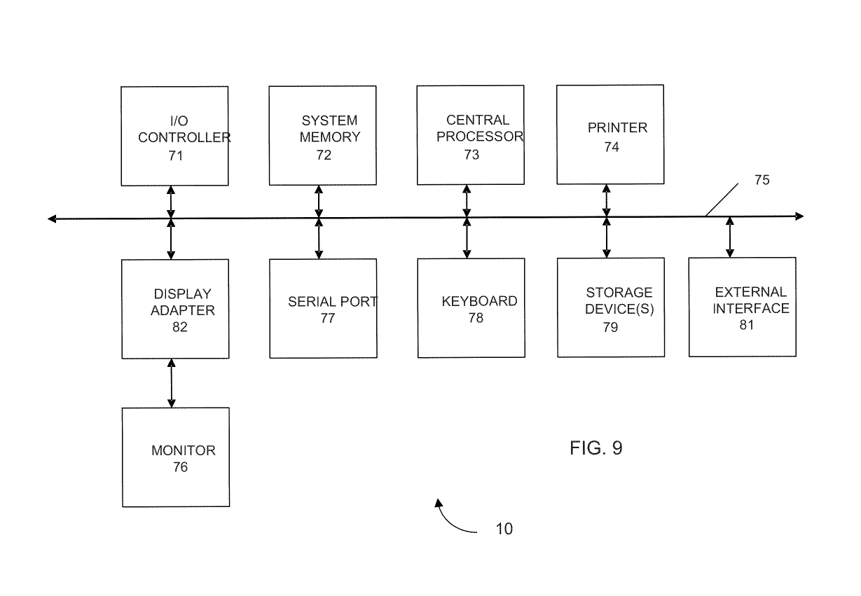

Any of the computer systems (e.g., computer system 680) mentioned herein may utilize any suitable number of subsystems. Examples of such subsystems are shown in FIG. 9 in computer apparatus 10. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 9 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of instructions from system memory 72 or the storage device(s) 79 (e.g., a fixed disk, such as a hard drive or optical disk), as well as the exchange of information between subsystems. The system memory 72 and/or the storage device(s) 79 may embody a computer readable medium. Any of the data mentioned herein can be output from one component to another component and can be output to the user.

A computer system can include a plurality of the same components or subsystems, e.g., connected together by external interface 81 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C# or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications, and descriptions mentioned here are incorporated by reference in their entirety for all purposes. None is admitted to be prior art.

What is claimed is:

1. A method of tuning a mass spectrometer using a cost function for optimizing a set of parameters for the mass spectrometer, each parameter corresponding to a different tunable element of the mass spectrometer, the cost function including an intensity term and a rectangularity term, the rectangularity term being a quantification of an extent that a first measured signal corresponding to a first mass-to-charge ratio approximates a rectangle, the method comprising:
for each of a plurality of iterations of an optimization process:
sending, by a computer system, commands to the mass spectrometer to obtain a calibration measured signal of a calibration sample, wherein the calibration measured signal includes the first measured signal, and wherein the commands specify current values for the set of parameters;
receiving the calibration measured signal at the computer system;
analyzing, by the computer system, the calibration measured signal to determine a current cost value for the cost function, the current cost value including contributions from the intensity term and the rectangularity term; and
selecting, by the computer system, one or more new values for the set of parameters based on the current cost value to optimize the cost function, the one or more new values for including in new commands to be sent to the mass spectrometer for a next iteration;
providing, by the computer system, final values for the set of parameters for use in operating the mass spectrometer to obtain a mass spectrum of a new sample.

2. The method of claim 1, wherein the rectangularity term is computed by:
defining a bounding box around the first measured signal; and
calculating a fraction of the bounding box that is filled with the first measured signal.

3. The method of claim 2, wherein a left edge of the bounding box is positioned at a first time when the first measured signal reaches a threshold value, wherein a right edge of the bounding box is positioned at a second time when the first measured signal drops below the threshold value, and wherein a top of the bounding box is at a maximum value of the first measured signal.

4. The method of claim 1, wherein the rectangularity term includes an exponent that is less than one.

5. The method of claim 1, wherein the cost function includes a resolution term that is a measure of an ability to resolve one mass from another using an autocorrelation matrix A, the autocorrelation matrix A being determined using the first measured signal.

6. The method of claim 5, further comprising:
creating a first reference basis function corresponding to the first measured signal;
determining a plurality of other reference basis functions by time shifting the first reference basis function;
calculating at least a portion of the autocorrelation matrix A using the first reference basis function and the plurality of other reference basis functions; and
computing a value of the resolution term using the at least a portion of the autocorrelation matrix A.

7. The method of claim 6, wherein the at least a portion of the autocorrelation matrix A includes specified matrix elements of a row of autocorrelation matrix A, and wherein computing the value of the resolution term using the at least a portion of the autocorrelation matrix A includes:
computing a difference between a first matrix element and a second matrix element.

8. The method of claim 6, wherein the at least a portion of the autocorrelation matrix A includes specified matrix elements of a row of autocorrelation matrix A, and wherein computing the value of the resolution term using the at least a portion of the autocorrelation matrix A includes:
computing a sum of differences between the matrix element of the row and a specified function, wherein the specified function has a maximum value that coincides with a maximum value of the matrix elements of the row.

9. The method of claim 8, wherein the specified function is a triangle.

10. The method of claim 6, wherein the first measured signal includes two-dimensional positions measured by a detector, wherein computing the value of the resolution term using the at least a portion of the autocorrelation matrix A includes:
creating a first single-value basis function corresponding to the first measured signal, wherein the first single-value basis function has one value for each time period of the first measured signal;
determining a plurality of other single-value basis functions by time shifting the first single-value basis function;
calculating at least a portion of a single-value autocorrelation matrix A2 using the first single-value basis function and the plurality of other single-value basis functions; and
computing a difference between the autocorrelation matrix A and the single-value autocorrelation matrix A2.

11. The method of claim 6, wherein the at least a portion of the autocorrelation matrix A includes the entire autocorrelation matrix A, and wherein computing the value of the resolution term using the at least a portion of the autocorrelation matrix A includes:
creating a statistically random cross-correlation b vector by simulating ion fluxes of a specified distribution of ions, the specified distribution of ions corresponding to an expected x;
solving Ax=b to obtain a solved x;
computing a difference between the solved x to the expected x.

12. The method of claim 11, wherein creating the statistically random cross-correlation b vector includes:
creating statistically random voxels or voxel planes of a simulated measured signal based on the first reference basis function.

13. The method of claim 1, wherein the optimization process optimizes one parameter at a time.

14. The method of claim 13, wherein the optimization process includes:
for a first iteration, obtaining cost values for a first group of N values of a first parameter while maintaining values of other parameters fixed;
identifying the largest M values of the first group of N values, M being an integer less than N;
for a second iteration, obtaining cost values for a second group of N values for the first parameter, wherein the second group of N values adds new cost values between the largest M values determined for the first group of N values; and
repeating a determination of identifying largest M values from a current group of N values and adding new cost values until a convergence criteria is satisfied.

15. The method of claim 1, wherein the set of parameters includes one or more of: resolving voltages of a mass filter, a number of RF cycles, settings of an ion lens set, an extraction energy of ions out of a cooling cell, a cooling cell offset, a cooling cell RF voltage, and a cooling cell drag field.

16. A computer product comprising a non-transitory computer readable medium storing a plurality of instructions that when executed control a computer system to tune a mass spectrometer using a cost function for optimizing a set of parameters for the mass spectrometer, each parameter corresponding to a different tunable element of the mass spectrometer, the cost function including an intensity term and a rectangularity term, the rectangularity term being a quantification of an extent that a first measured signal corresponding to a first mass-to-charge ratio approximates a rectangle, the instructions comprising:
for each of a plurality of iterations of an optimization process:
sending commands to the mass spectrometer to obtain a calibration measured signal of a calibration sample, wherein the calibration measured signal includes the first measured signal, and wherein the commands specify current values for the set of parameters;
receiving the calibration measured signal;
analyzing the calibration measured signal to determine a current cost value for the cost function, the current cost value including contributions from the intensity term and the rectangularity term; and
selecting one or more new values for the set of parameters based on the current cost value to optimize the cost function, the one or more new values for including in new commands to be sent to the mass spectrometer for a next iteration;
providing final values for the set of parameters for use in operating the mass spectrometer to obtain a mass spectrum of a new sample.

17. The computer product of claim 16, wherein the rectangularity term is computed by:
defining a bounding box around the first measured signal; and
calculating a fraction of the bounding box that is filled with the first measured signal.

18. The computer product of claim 16, wherein the cost function includes a resolution term that is a measure of an ability to resolve one mass from another using an autocorrelation matrix A, the autocorrelation matrix A being determined using the first measured signal.

19. The computer product of claim 18, further comprising:
creating a first reference basis function corresponding to the first measured signal;
determining a plurality of other reference basis functions by time shifting the first reference basis function;
calculating at least a portion of the autocorrelation matrix A using the first reference basis function and the plurality of other reference basis functions; and
computing a value of the resolution term using the at least a portion of the autocorrelation matrix A.

20. The computer product of claim 16, wherein the optimization process optimizes one parameter at a time, wherein the optimization process includes:
for a first iteration, obtaining cost values for a first group of N values of a first parameter while maintaining values of other parameters fixed;
identifying the largest M values of the first group of N values, M being an integer less than N;
for a second iteration, obtaining cost values for a second group of N values for the first parameter, wherein the second group of N values adds new cost values between the largest M values determined for the first group of N values; and
repeating a determination of identifying largest M values from a current group of N values and adding new cost values until a convergence criteria is satisfied.
